(19) United States
(12) Patent Application Publication
(10) Pub. No.: US 2023/0029665 A1
(43) Pub. Date: Feb. 2, 2023

(54) CENTRALIZED AND COORDINATED INSTALLATION OF SOLAR SYSTEMS

(71) Applicant: Terabase Energy, Inc., Berkeley, CA (US)

(72) Inventors: Matthew Campbell, Berkeley, CA (US); Brian Coleman, Portland, OR (US); Allan Daly, Albany, CA (US); Soren Jensen, Corte Madera, CA (US); Adam Hansel, Davis, CA (US); Sarika Kumar, Corvallis, OR (US); Johann Fritz Karkheck, Petaluma, CA (US)

(73) Assignee: Terabase Energy, Inc., Berkeley, CA (US)

(21) Appl. No.: 17/390,159

(22) Filed: Jul. 30, 2021

(51) Int. Cl. G06Q 10/06; G06Q 50/06; H02S 20/00

(52) U.S. Cl. CPC G06Q 10/06312; G06Q 10/063112; G06Q 50/06; H02S 20/00

(57) ABSTRACT

A system for centralized assembly and installation of large-scale solar systems is described. Embodiments of the invention transition the prior art approach of solar table assembly and installation at single location sites to a centralized and coordinated assembly factory that allows a more cost-effective and dynamic process of constructing large-scale solar systems. Additionally, embodiments of the invention provide an improved process of resource and personnel management during the construction process that improves cost and efficiency as conditions change at the construction site.

### TECHNICAL FIELD

The present disclosure relates generally to centralized assembly and installation of solar systems. More particularly, the present disclosure relates to a software-based system that analyzes resource and personnel information, design characteristics, and other parameters of a large-scale solar system to improve its efficiency and cost of installation.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge in this transition is the reduction in the high cost of installing these solar systems.

Large-scale solar panel systems typically include thousands of solar panels that are located across a multi-acre terrain and that are electrically coupled to provide a source of energy. These large-scale systems are oftentimes located in remote areas and require a significant investment in materials, resources and labor in their installation and design. The sourcing and delivery of materials and resources for these installations can be problematic and inconsistent. A further complication is the reliability of a deployed workforce to these remote areas and the high turnover of labor during the installation process. These issues further contribute to an increase in the cost and complexity of what is already a very cost-sensitive process.

FIG. 1 illustrates a typical prior-art installation process for solar systems. This prior-art installation process is implemented such that all mounting equipment for each solar panel is individually assembled and installed at its location within the larger system. The cost-effectiveness of this approach works fine within smaller solar deployments but struggles to cost-effectively scale to large solar systems as described below.

This traditional deployment 101 relies on materials being delivered to a deployment site via an access road. The materials are then processed and staged at the deployment site by a crew. A small portion of this delivered material is then moved by heavy equipment to a specific location where a solar panel and mounting equipment are assembled and installed at that location 102. The step is then repeated for an adjacent location 103 where materials are subsequently delivered, assembled and installed for a neighboring solar table within the system. While this approach may be effectively deployed in the installation of smaller solar systems, it becomes cost-prohibitive as the size of the system increases.

This time and labor-intensive process is further complicated by the inconsistent delivery of material and components over the entire installation process as well as reliability issues of the workforce deployed to install the solar panel system. One skilled in the art will recognize that delays or complications within such a serial installation process will introduce subsequent costs and delays in other downstream processes within the installation.

What is needed are systems, devices and methods that reduce the complexity and cost of the installation of large-scale solar panel systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures may be not to scale.

FIG. ("FIG.") 1 shows a prior art assembly and installation process of large-scale solar panel systems.

FIG. 2 is a diagram showing a centralized assembly and installation of a solar system in accordance with various embodiments of the invention.

FIG. 3 is a software system diagram for generating a coordinated and centralized solar system assembly and installation process in accordance with various embodiments of the invention.

FIG. 4 is a software system diagram for generating updates to a coordinated and centralized solar system assembly and installation process in accordance with various embodiments of the invention.

FIG. 5 is a centralized solar table assembly and installation analyzer in accordance with various embodiments of the present invention.

FIG. 6 is a real-time site analyzer in accordance with various embodiments of the invention.

FIG. 7 is a flowchart of an illustrative process for coordinating resources and personnel information to generate a centralized assembly and installation process for a large-scale solar system according to various embodiments of the invention.

FIG. 8 is a flowchart of an illustrative process for updating a centralized assembly and installation process for a large-scale solar system according to various embodiments of the invention.

FIG. 9 is an illustration showing the different systems on which various embodiments of the invention may function.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. Furthermore, the use of memory, database, information base, data store, tables, hardware, and the like may be used herein to refer to system component or components into which information may be entered or otherwise recorded.

Further, it shall be noted that: (1) certain steps may optionally be performed; (2) steps may not be limited to the specific order set forth herein; (3) certain steps may be performed in different orders; and (4) certain steps may be done concurrently.

Furthermore, it shall be noted that many embodiments described herein are given in the context of the assembly and installation of large numbers of solar tables within a system, but one skilled in the art shall recognize that the teachings of the present disclosure may apply to other large and complex construction sites in which resources and personnel are difficult to manage and accurately predict.

In this document, “large-scale solar system” refers to a solar system having 1000 or more solar panels. The word “resources” refers to material, parts, components, equipment or any other items used to construct a solar assembly and/or solar system. The word “personnel” refers to any laborer, worker, designer or individual employed to construct or design a solar table or solar system. The term “real-time” refers to updating a process based on information that has changed within a twenty-four-hour period. The term “solar table” refers to a structural assembly comprising a torque tube and/or purlins with module rails. Some types of solar tables may have supplemental structure that allows it to connect to foundations/piles while other types do not have this supplemental structure. A solar table may have (but is not required) solar panels and/or electrical harnesses.

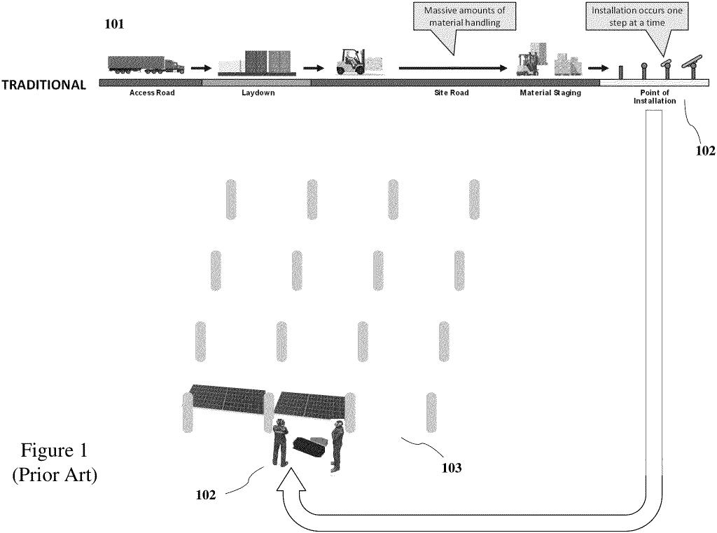

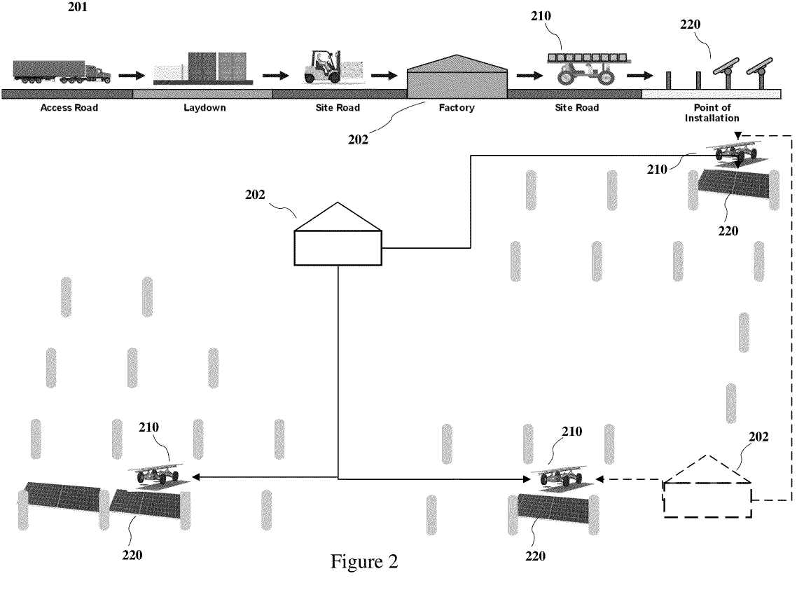

FIG. 2 provides an overview of a centralized solar table assembly and installation for large-scale solar systems according to various embodiments of the invention. Embodiments of the invention transition the prior art approach of assembly and installation at single location sites to a centralized and coordinated assembly factory that allows a more cost-effective and dynamic process of constructing large-scale solar systems. Additionally, embodiments of the invention provide an improved process of resource and personnel management during the construction process that improves cost and efficiency as conditions change at the construction site.

Resources are brought to a construction site 201 for a large-scale solar systems and initially processed. These resources are delivered to one or more assembly factories 202 where a coordinated and centralized solar table assembly process is performed. Detailed description of how the assembly process is generated and updated in real-time is provided later within this document. In addition, personnel management and efficiency improves as a larger portion of a site crew is centrally located and closer to resources needed for assembly of components within the large-scale solar system.

In certain embodiments, a construction site may have multiple centralized factories 202. As shown in FIG. 2, there are two centralized factories 202 strategically located at the site. The location and number of centralized factories 202 may depend on several parameters including the size of the site, the terrain of the site, the design of the site and other variables that relate to the construction of the large-scale solar system. For example, one skilled in the art will recognize that the characteristics of solar tables will vary across a large-scale system. The specific structural design of a solar table may depend on its relative location to the edge of a solar system, the specific terrain at which it is installed, the sun light conditions at its location and other parameters known to one of skill in the art. The construction process may be improved by including this solar table information in an assembly process and identifying one or more factory locations (and assembly processes therein) that take this information into account.

Assembled solar tables and equipment are moved from a factory 202 to a point of installation 220 via motorized vehicles 210. In certain embodiments, the motorized vehicles are specifically designed to transport solar tables along a site road to the point of installation 220. The motorized vehicles 210 may be driven by personnel, may be controlled by remote control or autonomously driven by a computer system. The time and/or sequence in which solar tables are delivered to points of installation 220 may depend on a variety of factors that may be analyzed to configure a preferred schedule. This analysis will be described in more detail later within this document.

One skilled in the art will recognize the advantages in configurability and adaptability of the centralized assembly and installation processes relative to the serial point-by-point installation process of the prior art. Users can configure solar table assembly and delivery processes based on (1) the design and terrain of the large-scale solar systems, (2) the availability and delivery of resources used to construct the solar tables and other components within the systems, and (3) the work schedule and availability of personnel needed during the construction process. Additionally, users can adapt in real-time assembly and construction processes as these parameters change.

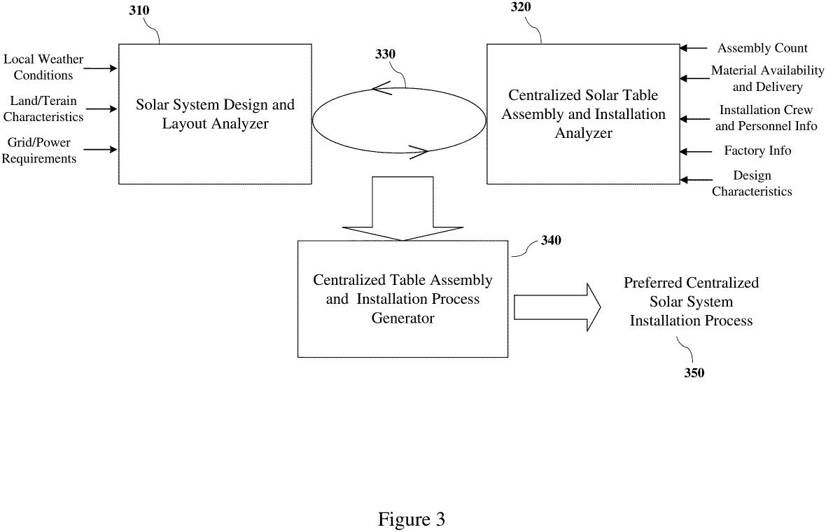

FIG. 3 illustrates a system that generates a preferred centralized solar table assembly and installation process according to various embodiments of the invention. This system analyzes a variety of parameters related to the assembly and installation of solar tables within a large-scale solar system. A solar system design and layout analyzer 310 processes a variety of parameters and generates a preferred design of a large-scale solar system according to various embodiments of the invention. Exemplary inputs such as (1) grid and power requirements, (2) land and terrain characteristics and (3) local weather conditions are provided such that a design of a large-scale solar power system may be generated. One skilled in the art will recognize that other parameters may also be used in this design process.

These parameters are analyzed to generate a preferred large-scale solar system based on the site at which it will be located. For example, flat terrain, mountainous terrain or other terrain types may suggest certain construction types of solar tables and structures to function properly over a long period of time within a particular terrain. Additionally, terrain and weather patterns may also affect the solar system design needed as well as the type of structure used to support the tables within the system itself. Weather patterns and terrains may also affect the shape of a large-scale solar system to realize certain performance levels. Furthermore, grid and power requirements may define the size and shape of a large-scale solar system as well as require a certain type or types of solar mounting equipment to be deployed therein. One skilled in the art will recognize that other parameters may be used in generating a preferred design of a large-scale solar power system.

Certain aspects of embodiments of the invention allow a design of large-scale solar system to be modified based on changing parameters that may not have been used in an initial design determination. For example, parameters such as resource availability and delivery schedules as well as an ability to establish a reliable workforce that can construct the system over time. Resource and personnel parameters are used to configure and adapt centralized solar table assembly processes and system installation processes according to embodiments of the invention. In certain examples, these parameters may also be used at various stages of a design and construction process to adapt the design of the system itself via feedback between the solar system design and layout analyzer 310 and a centralized solar table assembly and installation analyzer 320. Various features of the centralized solar tablel assembly and installation analyzer 320 are described below and its interaction with the solar system design and layout analyzer 310 are discussed later in this document.

The centralized solar table assembly and installation analyzer 320 analyzes a plurality of parameters related to resource and personnel availability to determine ways in which solar table assembly and installation may be improved according to various embodiments of the invention. In one example, the analyzer 320 receives solar table count information, material availability and delivery schedules, installation crew and personnel information, factory information and certain design characteristics. The solar table count information is used by the analyzer 320 to calculate the relative size of the large-scale solar system, to understand the number of different types of solar tables and/or solar table support structures deployed in the system and to correlate this information to the assembly process within one or more centralized factories 202. This correlation will also use resource information, such as material availability and delivery schedules, to refine the assembly process to improve efficiency and cost by optimizing the assembly of different solar tables based on resource information and eventual installation within the system. In certain embodiments, the analyzer 320 associates specific solar table assembly requirements such as required components and assembly time with resource information including material availability and delivery schedules to maximize the amount of solar tables assembled within a period of time at a factory, minimize cost or achieve other desirable objectives 202. In further embodiments, this process may be modified based on the system requirements of certain types of solar tables and where these solar table types/structures are installed such that the assembly of certain types of solar table types/structures are prioritized within the assembly process. This analysis allows an assembly prioritization to occur that maximizes solar table assembly throughput over a preferred period of time or improves other performance metrics associated with the assembly process.

The centralized solar table assembly and installation analyzer 320 also receives personnel information to analyze the workforce capabilities to support the solar table assembly and installation process according to various embodiments of the invention. The construction site for large-scale solar systems is oftentimes in remote locations and the management of a workforce can be challenging. The analyzer 320 receives information about personnel including the size of the workforce, the skillset of workers, the work schedule of workers and other personnel information known to one of skill in the art. The analyzer 320 analyzes this personnel information relative to the requirements of the construction project, the available resources and other parameters to further refine a preferred assembly and installation process. Embodiments of the invention are intended to maximize the efficiency and output of the workforce when deployed. Accordingly, the analyzer 320 may align projects and assembly of particular solar tables based on the capability of a currently deployed workforce. This coordination results in reductions in under-utilized personnel based on unavailability of work at a construction site that aligns with their particular skillset or expectation. This also allows coordination of personnel at a construction site with the anticipated resource availabilities on a particular day.

The centralized solar table assembly and installation analyzer 320 may also receive factory information to further coordinate and refine the solar table assembly according to various embodiments of the invention. This factory information may include the number of factories, assembly rates and capacity, potential location(s) within the construction site and other factors known to one of skill in the art. The factory information is analyzed relative to the resource information and personnel information to align factory procedures to available resources and personnel. In certain examples, factory information may also be used by the analyzer to correlate a factory’s capabilities or factories' capabilities to a map of the construction site which may be used to determine locations of a factory/factories within the site itself.

The centralized solar table assembly and installation analyzer 320 will receive design information and characteristics according to various embodiments of the invention. The design information and characteristics may include the overall size and shape of the design, the amount and position of solar tables, the solar table type and structure information, terrain information and other parameters known to one of skill in the art. The analyzer 320 uses this design information to align assembly processes to resource and personnel information as well as determine factors in the overall manufacturing scheme such as where and how many assembly factories are employed.

In certain embodiments, the centralized solar table assembly and installation analyzer 320 may feedback information 330 to the solar system design and layout analyzer 310 to provide coordination between the two analyzers and joint optimization of the large-scale solar system design and the assembly and installation process. This coordination may adjust the initial system design based on the feedback information 330 which may result in subsequent refinement of the assembly and installation analysis. For example, an initial system design may be based solely on power requirements, terrain characteristics and weather conditions. However, after resource and personnel information is processed, the analyzer(s) may determine that a design adjustment may result in a meaningful installation cost reduction with minor, or if any, performance changes.

In other embodiments, the initial design is static and the analyzer 320 processes resource and personnel information to identify a preferred assembly and installation process for that particular design.

A centralized table assembly and installation process generator 340 receives information from the above-described analysis examples and generates a preferred centralized solar system installation process 350 according to various embodiments of the invention. In one example, this generator 340 receives analyzed information from the coordinated processing between the solar system design and layout analyzer 310 and the centralized solar table assembly and installation analyzer 320. In another example, the generator 340 receives information that is uncoordinated between the two analyzers 310, 320. Based on this information, a preferred installation process or processes 350 is generated that implements centralized assembly of solar tables within one or more factories, and the subsequent installation of the assembled solar tables at corresponding locations within the system.

In various embodiments, the preferred centralized solar system installation process 350 will provide detailed processes in which a large-scale solar system is installed at a construction site. These processes may include (1) the identification and location of one or more factories, (2) a delivery schedule of resources comprising resource amounts, resource types, delivery dates and locations, (3) allocation of resources across the one or more factories including resource amounts, types and dates, (4) allocation of personnel across the one or more factories including personnel skillsets, amount of personnel and work schedules for personnel, (5) assembly sequences at each factory for solar tables including types/structures of solar tables, schedules of solar table assembly and amounts to be assembled, and (6) installation processes and times for integrating solar tables within the large-scale solar power system.

The preferred centralized solar system installation process 350 may be modified as conditions change relative to resources and personnel information at the construction site according to various embodiments of the invention. For example, if a particular delivery of resources is delayed a few days or some of the workforce fails to show up at the work site on a particular day, these parameter changes may be provided to the system and a modified installation process is generated that accounts for these parameter changes. This ability to change the installation process to account for real-time changes in resources or personnel allows the construction site to reduce the harm to the installation cost and efficiency that would otherwise be caused by these events.

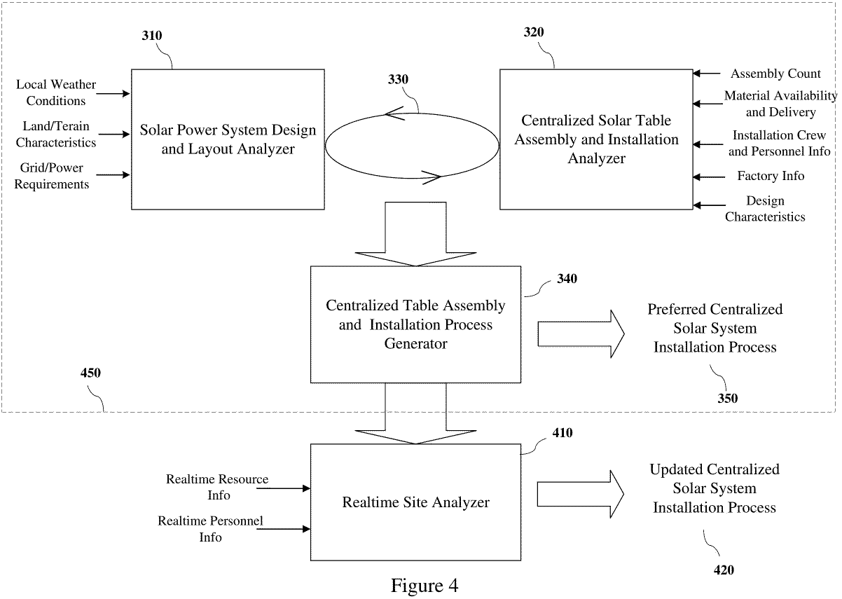

FIG. 4 illustrates a system that allows real-time modifications to a solar table assembly installation process based on changes in resources and/or personnel at a construction site according to various embodiments of the invention. As shown, a real-time site analyzer 410 receives information about a pre-calculated solar table installation process 350 that had been previously calculated 450. This information may be the process itself 350 or analysis information that was used to generate the installation process 350. The real-time site analyzer also receives real-time resource information as well as real-time personnel information. Examples of real-time resource information may include a delay in the delivery of certain components used to assemble solar tables or equipment failure at the construction site. This real-time resource information may render an installation processed to be less ideal when it was based on a timely delivery of the components and/or all of the equipment functioning.

The real-time site analyzer 410 identifies and correlates this real-time information to the underlying processes within the overall installation process. Based on this correlation, the installation process may be modified and an updated centralized solar table installation process 420 is generated. For example, if a delivery of a particular component is delayed a few days, the system can update the solar table assembly processes such that assembly work that was scheduled to be performed in the future is done early to offset at least some of the costs associated with the delivery delay. As previously discussed, large-scale solar plant construction sites are oftentimes located in remote areas which renders resource delivery and workforce availability difficult to predict. The real-time site analyzer 410 provides the system an ability to reduce the inefficiencies caused by these problems.

One skilled in the art will recognize that modifications to a large-scale solar installation site, on which thousands of solar tables are being assembled and installed, presents difficulties in completely understanding the effects of resource and personnel variations across the entire site. The automated system described relative to embodiments of the invention is able to quickly correlate these effects and reduce the damage caused thereby.

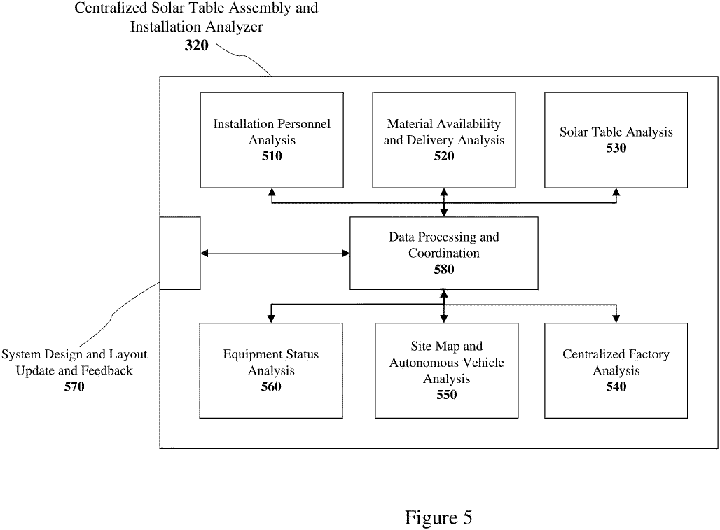

FIG. 5 illustrates a centralized solar table assembly and installation analyzer 320 according to various embodiments of the invention. As previously discussed, the analyzer 320 processes resource and personnel information to enable an installation process to be generated that is correlated across this different information.

In certain embodiments, the centralized solar table assembly and installation analyzer 320 comprises an analyzer that processes personnel information 510, an analyzer that processes material availability and delivery 520, a solar table analyzer 530, an analyzer that processes equipment 560 that is deployed or will be deployed at the site, a site map and autonomous vehicle analyzer 550 and a centralized factory analyzer 540. A data processing and coordination processor 580 receives this information to correlate it across the construction site. One skilled in the art will recognize that other information may also be processed within the analyzer to improve efficiency and cost metrics for the installation process.

The installation personnel analyzer 510 processes personnel information related to the labor force to be employed at the construction site. The personnel information may also be applied to personnel working remotely from the site. In certain embodiments, the analyzer 510 determines an anticipated labor force for each day of work on the construction site. The analyzer 510 also determines the skillset and capabilities of this labor force so that processes each day can be aligned to this anticipated labor capacity. The analyzer 510 may also include assumed parameters relating to percentage of workers who are unable to work due to illness or other issues. In certain embodiments, the analyzer 510 generates an anticipated labor capacity both in terms of the number of workers and their corresponding skill set on a day-by-day basis. One skilled in the art will recognize that this processed personnel information may provide this information in other time frames from hourly, daily, multi-daily and weekly depending on its configuration. This anticipated labor capacity information is provided to the data processing and coordination analyzer 580 for correlation across other relevant information.

The material availability and delivery analyzer 520 provides an analysis of the materials and components used in assembling the solar tables and the structures used to integrate the tables into the system according to various embodiments of the invention. In some examples, the analyzer 520 processes a delivery and availability schedule of the materials and components over a period of construction time for the site. Delivery of materials can oftentimes be difficult to coordinate so the analyzer 520 is able to provide information that allows the system to adjust assembly and installation procedures based on the delivery schedule. As discussed above, solar tables may differ across the site itself and require different components. Solar tables near the edge of the site may require thicker frames to support higher stress levels than those near the center of the system. There may be other variations across solar tables and integration components that require different materials and components. Supply chain and source availability may create significant delays in the delivery of a subset of material or components to the construction site. The analyzer 520 allows the system to account for these delays and coordinate assembly and installation processes that reduces the overall delay and cost caused thereby. This anticipated material availability and delivery information is provided to the data processing and coordination analyzer 580 for correlation across other relevant information.

The solar table analyzer 530 processes specific information about the solar tables being deployed in the large-scale solar system according to various embodiments of the invention. This analyzer 530 processes specific information about the types of solar tables to be deployed, the amount of each type of solar table and the location of each solar table within the system. This analyzed information allows enhanced coordination between resource availability and solar table assembly and installation. The solar table information is provided to the data processing and coordination analyzer 580 for correlation across other relevant information.

The equipment status analyzer 560 process information about anticipated equipment availability over a period of time during construction according to various embodiments of the invention. Oftentimes, equipment is leased for a period of time during construction so that meaningful visibility into equipment availability may be processed. Additionally, redundancies within equipment availability may be planned during the construction process. There are also predictive models that can estimate breakdowns across a large pool of equipment. This information may be processed across each type of equipment, and the corresponding work that each type of equipment will perform, to estimate equipment availability information. This equipment availability information is provided to the data processing and coordination analyzer 580 for correlation across other relevant information.

The site map and autonomous vehicle analyzer 550 process information about a map of solar tables, access roads, electrical connectivity, factories and other structures within site according to various embodiments of the invention. This map may include specific information about the type and location of each solar table to be installed, which roads or access trails allow access to each installation location and electrical connectivity of the solar tables within the site. The map may also include locations and/or proposed locations for one or more factories used to assemble solar tables. The map may also contain specific information about the terrain including incline/decline information, area and objects within the site itself. The map may also allow for virtual mapping that defines movement capabilities for vehicles either through autonomous movement, remote control or an individual driving the vehicle. This information allows coordination of the movement of solar tables, resources and personnel throughout the site. This map information is provided to the data processing and coordination analyzer 580 for correlation across other relevant information.

The centralized factory analyzer 540 processes information specific to one or more factories located in or planned to be located within a site according to various embodiments of the invention. This analyzer 540 analyzes information such as the specific assembly processes supported by a factory, the location of a factory, potential other locations of a factory, connectivity of a factory to installation points within the site, deployed workforce at a factory and material availability at a factory. This information allows for the coordination of factory solar table assembly processes, delivery of solar tables to installation points, allocation of solar table assembly across multiple factories, scheduling of assembly processes and other parameters known to one of skill in the art. This factory information is provided to the data processing and coordination analyzer 580 for correlation across other relevant information.

The data processing and coordination analyzer 580 receives various information about resources, personnel, construction site and/or other parameters and generates processes that improve or optimize a large-scale solar system installation. This installation comprises at least one centralized factory in which assembly processes are defined that account for resource and personnel variables. In certain embodiments, the improved processes may relate to a previously determined solar system design where the resources and personnel are managed relative thereto. In other embodiments, the management of resources and personnel may be further coordinated with the design itself to attempt additional performance improvements and/or cost reductions by modifying the system design relative to resource and personnel information.

The definition of these processes may be coordinated via an interface 570 to the system design and layout analyzer 310. This coordination may be performed by a processing unit(s) in one or more of the analyzers or external to the analyzers.

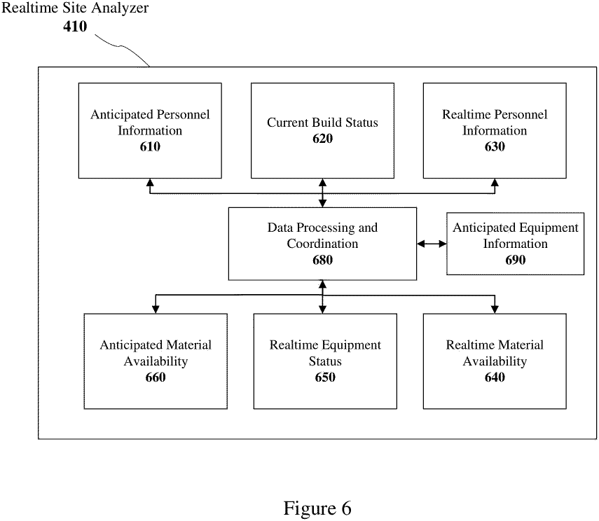

As previously discussed, resource and personnel parameters are likely to change over time and affect the efficiency of the assembly processes generated by the system. FIG. 6 illustrates a real-time site analyzer 410 according to various embodiments of the invention. As shown, this analyzer 410 identifies differences between anticipated resource and personnel availability versus real-time resource and personnel availability. Based on discrepancies between anticipated and real-time, the system can adjust one or more processes in assembly and/or installation to offset at least a portion of the lost efficiency.

The real-time site analyzer 410 comprises anticipated personnel information 610, current build status 620, real-time personnel information 630, anticipated material availability 660, real-time material availability 640, anticipated equipment information 690 and real-time equipment status 650. The real-time personnel information 630, real-time material availability 640 and real-time equipment status 650 may be provided by an operator at the site on a daily or multi-daily basis according to various embodiments of the invention. The real-time material availability 640 may be tied to a particular delivery of goods or may be input on a material-by-material basis. This real-time material availability 640 may be provided by an individual or automatically generated by systems that monitor material availability. Real-time personnel information 610 may be a single input of the number of workers available on a particular day or may go into additional detail including skillset and experience. The real-time equipment status 650 may be provided by an individual at the site that identifies which pieces of equipment are either inoperable or unavailable on a particular day or multi-day period. This real-time equipment status 650 may be compared to anticipated equipment information 690 so that processes may be adjusted based on differences between anticipated equipment availability and real-time equipment availability. The real-time equipment status 650 may also be provided remotely or automatically generated by the equipment itself.

The data processing and coordinator 680 compares the real-time data to the anticipated data and correlates the difference across the previously identified assembly and installation processes. One or more of these processes may be modified to offset at least a portion of the unanticipated problem in resources or personnel. The system may also maintain a history of the real-time information for later analysis.

The results of the various embodiments described above are correlated and improved processes that are implemented in the construction of large-scale solar systems. This improvement results from an analysis of anticipated resource and personnel information that is applied to a centralized solar tablel assembly and installation architecture. These processes may be further modified as anticipated resources and personnel are different than actual numbers at the site on a daily or multi-daily basis.

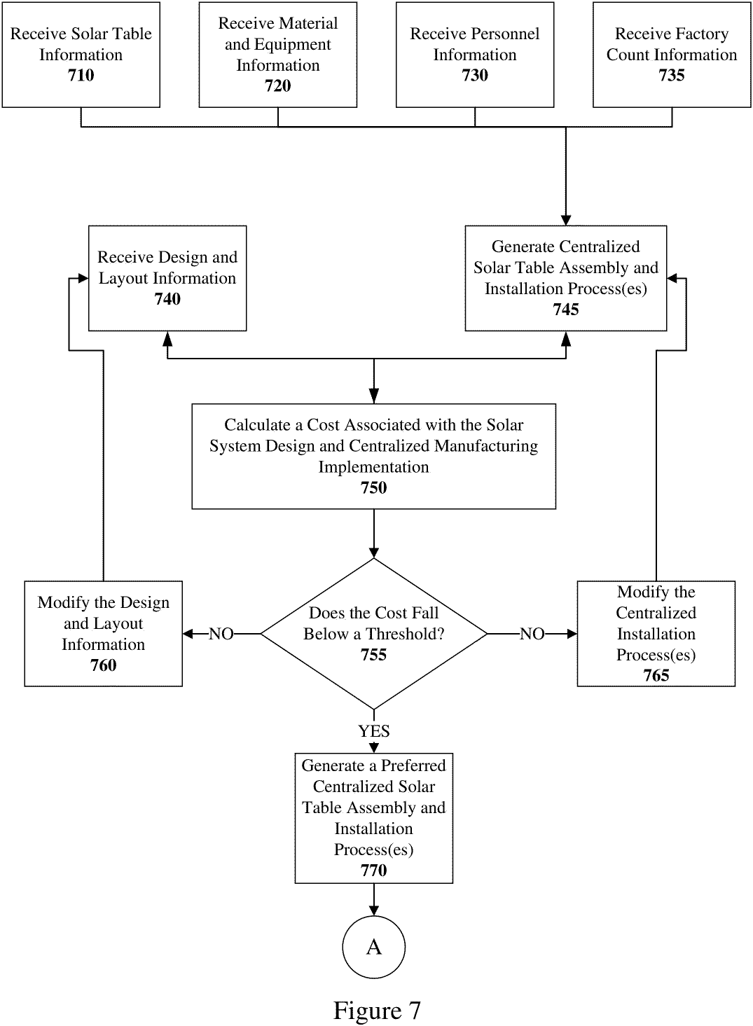

FIG. 7 is a flowchart of an illustrative process for coordinating resources and personnel information to generate a centralized solar system assembly and installation process according to various embodiments of the invention. As shown, solar table information 710, material and equipment information 720, personnel information 730, and factory information 735 are received. This information may be manually inputted by an individual into a computer system or retrieved from one or more storage devices.

A centralized solar table assembly and installation process or processes are generated 745 based at least partially on the received information. This process(es) is generated by correlating the received information together across various assembly and installation options and selecting one or more preferred processes. In certain embodiments, design and layout information is received 740 and included in the generation of the process(es).

A cost is calculated 750 and associated with the generated centralized solar table assembly and installation process(es). This cost is used to determine a cost estimate (e.g., money, time, etc.) for the generated process(es). In certain embodiments, this cost relates to an approximation or other relation of overall expenses in installing a large-scale solar system or a portion of a large-scale solar system.

The calculated cost is compared 755 to a threshold value to determine if the generated process(es) is (1) viable, (2) meets certain business objectives, (3) requires another iteration of the cost generation process based on modified process(es), and/or (4) meets certain objectives and the analysis can stop. If certain objectives are not met, a modification to the design and layout occurs 760 and/or a modification to the centralized solar table and installation processes 765 occurs after which further analysis occurs. However, if certain threshold criteria are met, then a preferred centralized solar table assembly and installation process(es) are generated 770.

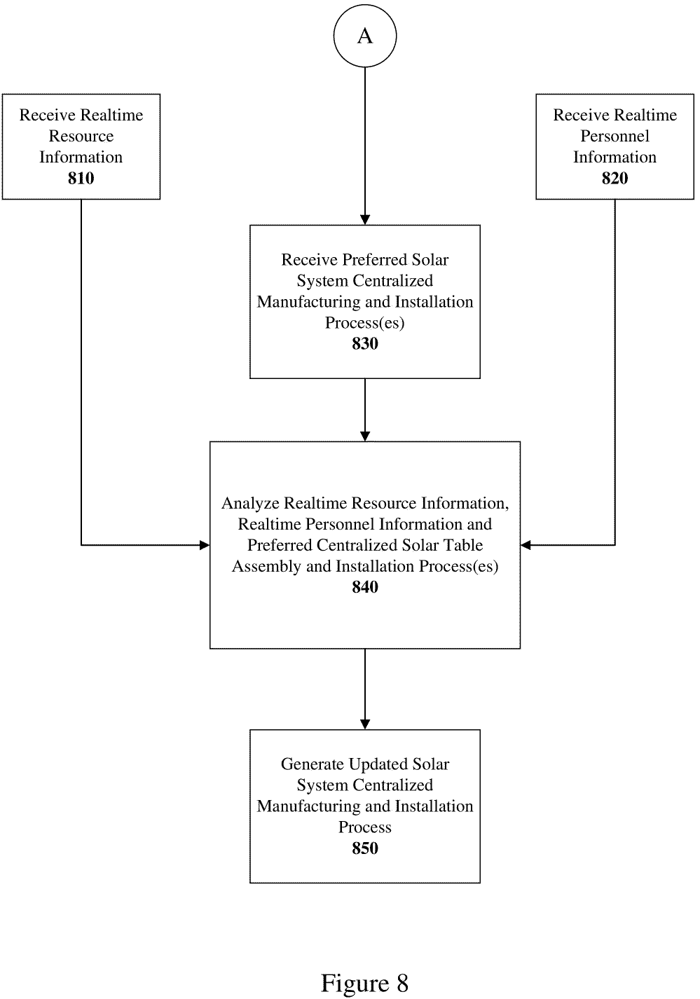

FIG. 8 is a flowchart illustrating an exemplary process in which the centralized solar table assembly and installation process(es) may be modified based on real-time information according to various embodiments of the invention. As shown, one or more preferred centralized solar table assembly and installation processes are received 830.

In order to account for unanticipated changes at the construction site, real-time resource information 810 and real-time personnel information 820 are received. The real-time resource and personnel information, and the centralized solar table assembly and installation process is analyzed 840. This analysis comprises identifying differences between anticipated resource and personnel availability with actual information. Based on these differences, the assembly and installation process steps are correlated to the real-time information to determine if modifications would result in improvements to cost and/or efficiency. If such benefits are identified, then an updated centralized solar table assembly and installation process is generated 850.

Aspects of the present patent document are directed to information handling and processing systems on which the analyzers, generators, process steps and other elements may operate. For purposes of this disclosure, an information handling and processing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output devices, such as a speaker, a microphone, a camera, a keyboard, a mouse, touchscreen and/or a video display. The information handling system may also include one or more buses operable to transmit communications between the various hardware components.

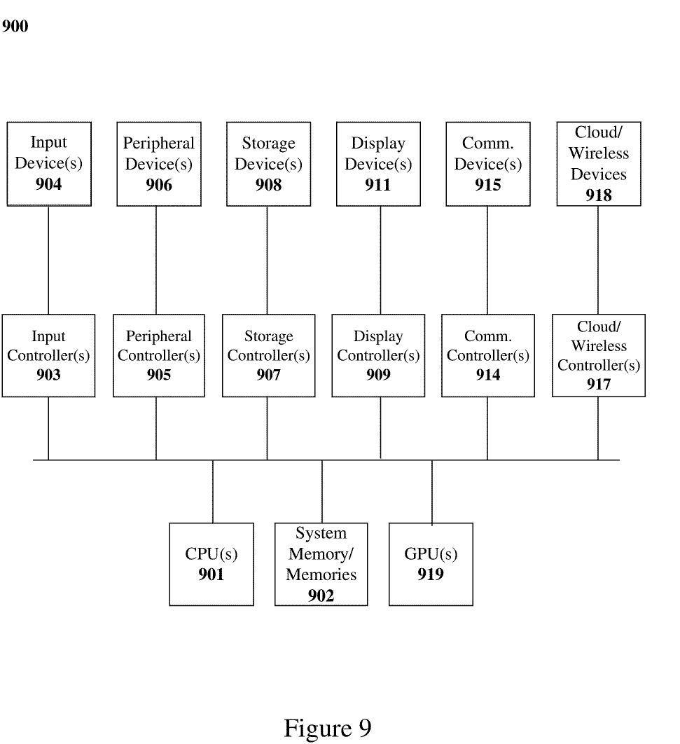

FIG. 9 depicts a simplified block diagram of a computing device / information handling system (or computing system) according to embodiments of the present disclosure. It will be understood that the functionalities shown for system 900 may operate to support various embodiments of a computing system-although it shall be understood that a computing system may be differently configured and include different components, including having fewer or more components as depicted in FIG. 9.

As illustrated in FIG. 9, the computing system 900 includes one or more central processing units (CPU) 901 that provides computing resources and controls the computer. CPU 901 may be implemented with a microprocessor or the like and may also include one or more graphics processing units 919 and/or a floating-point coprocessor for mathematical computations. System 900 may also include a system memory 902.

A number of controllers and peripheral devices may also be provided, as shown in FIG. 9. An input controller 903 represents an interface to various input device(s) 904, such as a keyboard, mouse, touchscreen, and/or stylus. The computing system 900 may also include a storage controller 907 for interfacing with one or more storage devices 908 each of which includes a storage medium such as flash memory or disk memory or RAM/ROM memory, or an optical medium that might be used to record programs of instructions for operating systems, utilities, and applications, which may include embodiments of programs that implement various aspects of the present invention. Storage device(s) 908 may also be used to store processed data or data to be processed in accordance with the invention. The system 900 may also include a display controller 909 for providing an interface to a display device 911, which may be a cathode ray tube, a thin film transistor display, organic light-emitting diode, electroluminescent panel, plasma panel, or other type of display. The computing system 900 may also include one or more peripheral controllers or interfaces 905 for one or more peripherals. Example of peripheral may include one or more printers, scanners, input devices, output devices, sensors, and the like. A communications controller 914 may interface with one or more communication devices 915, which enables the system 900 to connect to remote devices through any of a variety of networks including the Internet, a cloud resource (e.g., an Ethernet cloud, a Fiber Channel over Ethernet / Data Center Bridging cloud, etc.), a local area network, a wide area network, a storage area network, or through any suitable electromagnetic carrier signals including infrared signals. Cloud or wireless controller 917 may also be provided that interface with various cloud or wireless devices 918.

In the illustrated system, all major system components may connect to a bus, which may represent more than one physical bus. However, various system components may or may not be in physical proximity to one another. For example, input data and/or output data may be remotely transmitted from one physical location to another. In addition, programs that implement various aspects of the invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Aspects of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A method for generating a centralized solar table assembly and installation process, the method comprising the steps of:
receiving an initial design of a large-scale solar system having a plurality of solar tables;
receiving resource information relating to resources used in centralized assembly processes of the plurality of solar tables at a factory and installation of the assembled plurality of solar tables within the large-scale solar power system;
receiving personnel information related to a workforce used in the centralized solar table processes and installation; and
evaluating the initial design, the resource information and the personnel information to determine a preferred centralized solar table assembly and installation process, the correlation identifying at least one cost or schedule improvement within the preferred centralized solar table assembly and installation process.

2. The method according to claim 1 wherein a location of the factory is based on the correlation of the initial design and the resource information.

3. The method of claim 1 wherein the centralized table assembly processes of the plurality of solar tables occur at a plurality of factories.

4. The method of claim 1 wherein the preferred centralized solar table assembly and installation process comprises a sequence of assembly steps, the sequence being at least partially dependent on the received resource information.

5. The method of claim 4 wherein the sequence of assembly steps is based at least in part on the received personnel information.

6. The method of claim 4 wherein the sequence of assembly steps is based at least in part on structural characteristics of the plurality of solar tables being assembled.

7. The method of claim 1 further comprising the steps of:
receiving real-time resource information and real-time personnel information related to the large-scale solar system;
identifying a first set of differences between the real-time resource information and the received resource information;
identifying second set of difference between the real-time personnel information and the received resource;
correlating the first and second set of differences across the preferred centralized solar table assembly and installation process; and
modifying the preferred centralized solar table assembly and installation process based on the correlation.

8. The method of claim 1 wherein the preferred centralized solar table assembly and installation process comprises at least some steps related to transport of assembled solar table to installation points.

9. The method of claim 1 wherein feedback correlation occurs between the initial design of the large-scale solar system and the preferred centralized solar table assembly and installation process, the feedback correlation resulting in a modified centralized solar table assembly and installation process.

10. The method of claim 1 wherein solar table information is received and correlated across the resource information, the personnel information and the initial design of the large-scale solar system.

11. The method of claim 1 wherein the personnel information comprises at least one of a size of workforce and a skillset of a workforce.

12. The method of claim 1 further comprising the step of generating a virtual map of a construction site for the large-scale solar system, the virtual map comprising at least one factory location, a plurality of access roads and a plurality of solar table installation sites.

13. The method of claim 12 wherein an autonomous vehicle transports a solar table on an access road within the plurality of access roads to a solar table installation site within the plurality of solar table installation sites.

14. A centralized solar table assembly and installation analyzer comprising:
an installation personnel analyzer that process information about personnel that assemble a plurality of solar tables within a centralized factory and install the plurality of solar tables within a large-scale solar system;
a material availability and delivery analyzer that process information about material used to assemble the plurality of solar tables;
an equipment status analyzer that process information about equipment used to assemble the plurality of solar tables and install the plurality of solar tables; and
a data processing and coordination analyzer coupled to receive the processed personnel information, the processed material availability and delivery information and the equipment status information, the data processing and coordination analyzer generates correlated information across the processed personnel information, processed material availability and delivery information and the equipment status information.

15. The centralized solar table assembly and installation analyzer of claim 14 further comprising a centralized factory analyzer that processes information related to at least one centralized factory within the large-scale solar system, the processed centralized factory information being provided to the data processing and coordination analyzer.

16. The centralized solar table assembly and installation analyzer of claim 14 further comprising a site map and autonomous vehicle analyzer that generates a virtual map of a construction site for the large-scale solar system, the virtual map comprising at least one factory, a plurality of access roads and a plurality of solar table installation sites.

17. The centralized solar table assembly and installation analyzer of claim 16 wherein an autonomous vehicle transports a solar table within the plurality of solar tables from the at least one factory to a solar table installation site within the plurality of solar table installation sites.

18. A real-time site analyzer comprising:
a first storage element that stores anticipated personnel information associated with a centralized solar table assembly and installation process;
a second storage element that stores anticipated material availability associated with the centralized solar table assembly and installation process; and
a data processing and coordination analyzer coupled to receive real-time personnel information and real-time material availability information, the data processing and coordination analyzer compares the real-time personnel information to the anticipated personnel information and compares the real-time material availability information to the anticipated material availability and generates a modified centralized solar table assembly and installation process.

19. The real-time site analyzer of claim 18 wherein real-time equipment information is compared to anticipated equipment information to supplement the generation of the modified centralized solar table assembly and installation process.

20. The real-time site analyzer of claim 18 wherein the real-time material availability information and the real-time personnel information are stored within a historical database.
